(19) United States
(12) Patent Application Publication
(10) Pub. No.: US 2020/0284081 A1
(43) Pub. Date: Sep. 10, 2020

(54) DOOR APPARATUS AND METHODS OF INSTALLING SAME

(71) Applicant: Dandy Products, LLC, Statesville, NC (US)

(72) Inventor: Kenneth W. Teeters, Mooresville, NC (US)

(21) Appl. No.: 16/786,632

(22) Filed: Feb. 10, 2020

Related U.S. Application Data
(60) Provisional application No. 62/803,139, filed on Feb. 8, 2019.

(51) Int. Cl. E05F 11/04; E05D 3/02; E05B 1/00; E05F 11/54

(52) U.S. Cl. CPC E05F 11/04; E05D 3/02; E05Y 2900/132; E05F 11/54; E05B 1/0015

(57) ABSTRACT

A door apparatus for installing in the vent opening of poultry house can include a transparent or translucent panel positioned within a substantially rectangular frame. The door apparatus can include a handle apparatus attached to the outer surface of the transparent or translucent panel. The handle apparatus can includes an elongate section extending outwardly from the outer surface of the transparent or translucent section having an opening formed therein for receiving an elongate connecting member, such as a cable or cord.

### CROSS REFERENCE TO RELATED APPLICATIONS

This application claims priority to U.S. Provisional Patent Application No. 62/803,139, filed Feb. 8, 2019, which is incorporated herein by reference.

### TECHNICAL FIELD

The present invention relates to the mechanical arts. One embodiment of the invention comprises a window apparatus for use in poultry houses. Another embodiment of the invention comprises a door apparatus for use in poultry houses. Another embodiment of the invention comprises a self-closing handle for use in poultry houses.

### BACKGROUND

Controlling the level of light within a poultry house can be a critical factor in maximizing bird health and production, particularly in particularly in broiler houses in which birds are grown for consumption. Therefore, poultry houses have generally been constructed with minimal or no windows at all. However, in recent times there has been a movement toward increasing the amount of outdoor light that is allowed to penetrate into the interior of poultry houses. As such, there is a need for devices and methods to increase the amount of outdoor sunlight allowed into the interior of poultry houses.

### SUMMARY

Accordingly, an object of the present invention is to provide a door apparatus that can be installed in the vents of existing poultry houses. Another object of the present invention is to provide a self-tensioning handle that can be used on vent doors in poultry houses. These and other objectives of the invention can be achieved in various embodiments of the invention described herein.

One embodiment of the invention comprises a window apparatus adapted for use in a poultry house.

Another embodiment of the invention comprises a door apparatus adapted to be installed within an existing vent of a poultry house.

According to an embodiment of the invention, the door apparatus is comprised of poly-carbonate and is transparent or translucent.

Another embodiment of the invention comprises a self-tensioning handle apparatus.

According to an embodiment of the invention, the handle apparatus can be used on a vent door of a poultry house.

Another embodiment of the invention comprises a kit for installing a door in a vent opening of a poultry house. The kit includes a transparent or translucent panel positioned within a substantially rectangular frame, an elongate rod positioned within the frame. The elongate rod has first and second opposite ends extending outwardly from the frame. The kit includes a first mounting bracket for receiving the first end of the rod and a second mounting bracket for receiving the second end of the rod.

According to an embodiment of the invention, a handle apparatus can be attached to an outer surface of the transparent or translucent panel. The handle apparatus can include an elongate section extending outwardly from the outer surface of the transparent or translucent panel, and an opening can be formed therein for receiving an elongate connecting member, such as a cable or cord.

According to an embodiment of the invention, the handle apparatus is comprised of glass filled nylon.

Another embodiment of the invention comprises a method of installing a door apparatus in a vent opening of a poultry house. The door apparatus comprises a transparent or translucent panel positioned within a substantially rectangular frame, and an elongate rod partially positioned within the frame having first and second opposite ends extending outwardly from the frame. A first mounting bracket is attached proximate a first corner of the vent opening, and attaching a second mounting bracket is attached proximate a second corner of the vent opening. The first end of the rod is positioned in the first mounting bracket, and the second end of the rod is positioned in the second mounting bracket, whereby the frame is pivotable about the rod between a closed position wherein the vent opening is closed by the door apparatus and an open position wherein the vent opening is exposed.

According to an embodiment of the invention, the door apparatus can include a handle apparatus attached to an outer surface of the transparent or translucent panel, The handle apparatus includes an elongate section extending outwardly from the outer surface of the transparent or translucent section. An elongate connecting member is attached to the elongate section.

According to another embodiment of the invention, the elongate connecting member is a cable, cord, rope or string.

According to another embodiment of the invention, a pulley is positioned proximate the door apparatus, and the elongate connecting member is positioned through the pulley.

According to a winch is attached to an end of the elongate connecting member to the winch.

### BRIEF DESCRIPTION OF THE DRAWINGS

FIG. 1 is a perspective view of a handle apparatus according to an embodiment of the invention;

FIG. 2 is an exploded perspective view of a door apparatus according to an embodiment of the invention;

FIG. 3 is a partial perspective view of the door apparatus of FIG. 2;

FIG. 4 is a perspective view of the door apparatus of FIG. 2;

FIG. 4A is an enlarged partial perspective view of the door apparatus of FIG. 2;

FIG. 5 is a perspective view of the door apparatus of FIG. 2;

FIG. 6 is a perspective view of a door apparatus according to another embodiment of the invention;

FIG. 7 is a perspective view of the door apparatus of FIG. 6;

FIG. 8 is a perspective view of the door apparatus of FIG. 6;

FIG. 9 is a perspective view of the door apparatus of FIG. 6;

FIG. 10 is a front elevation view of a handle apparatus according to another embodiment of the invention;

FIG. 11 is a rear elevation view of the handle apparatus of FIG. 10; and

FIG. 12 is a side elevation view of the handle apparatus of FIG. 10.

### DETAILED DESCRIPTION OF PREFERRED EMBODIMENTS

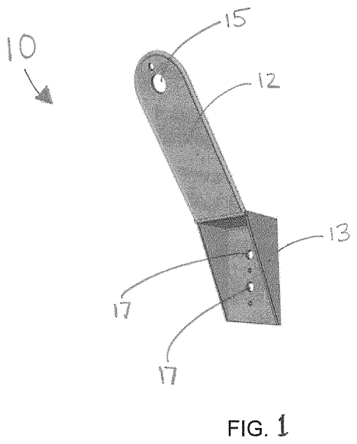

A handle apparatus according to a preferred embodiment of the invention is illustrated in FIG. 1, and shown generally at reference numeral 10. The handle apparatus 10 comprises a flat tongue-shaped member 12 extending upwardly from a mounting section 13, as shown in FIG. 1. The handle apparatus 10 is made of a strong, resilient material, such as glass filled nylon. The handle apparatus 10 can be mounted on a vent door in a poultry house, and can be used to increase the tension on the door to tighten the seal of the door and the poultry house. The handle apparatus 10 can be used on a variety of doors, including European style vent doors.

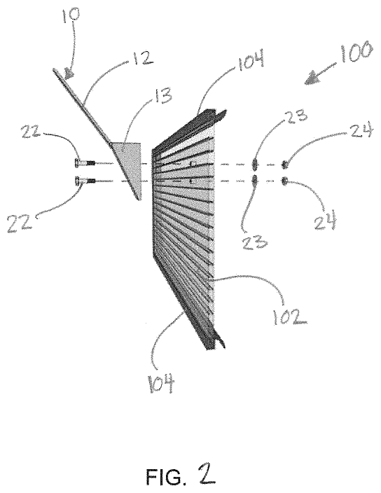

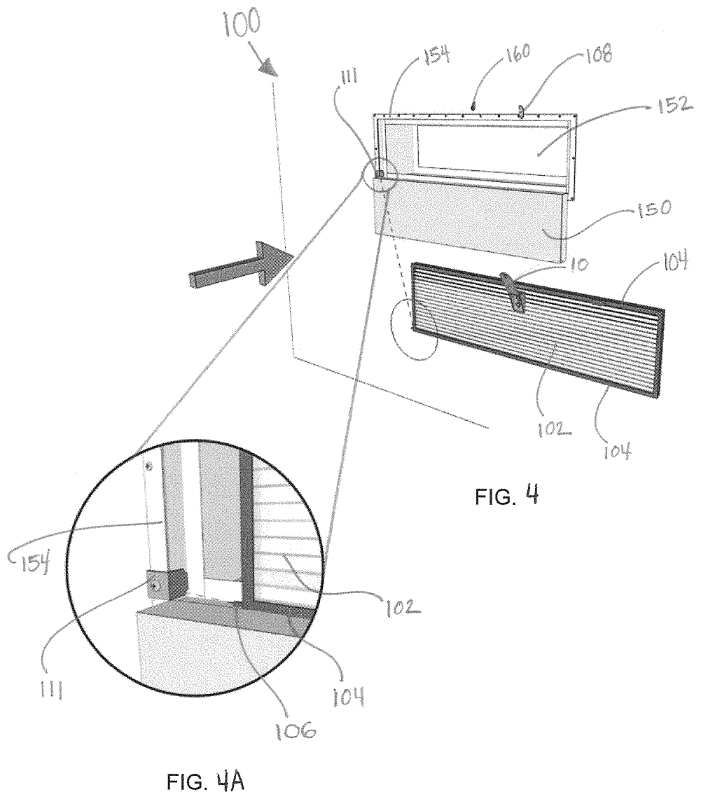

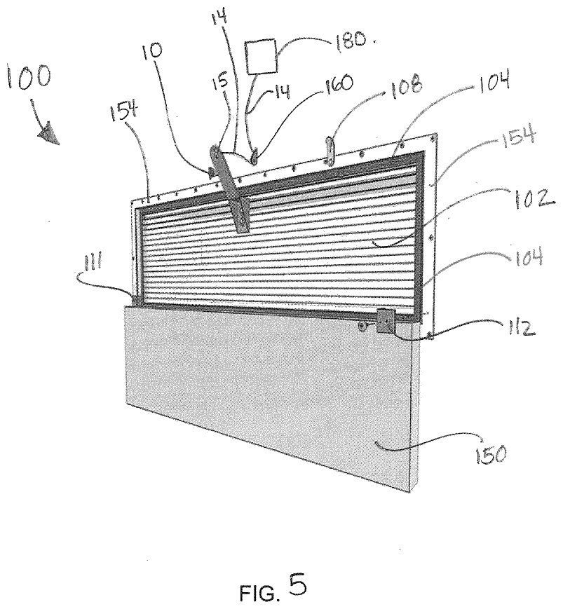

A door apparatus for use according to a preferred embodiment of the invention is illustrated in FIG. 2-5, and shown generally at reference numeral 100. The door apparatus 100 is adapted for use in a poultry house. The door apparatus 100 comprises the handle apparatus 10, and a transparent or translucent panel 102 contained within an outer frame 104. The handle apparatus 10 is mounted on the front surface of the panel 102, as shown in FIGS. 2 and 5. The transparent or translucent panel 102 is preferably comprised of polycarbonate.

Openings 17 are formed in the mounting section 13 of the handle apparatus 10. Screws 22 can be positioned through the openings 17 of the mounting section 13 and through the panel 102, and washers 23 and bolts 24 are positioned on the screws 22 from the opposite side of the panel 102 to mount the handle apparatus 10 to the panel 102, as shown in FIG. 2.

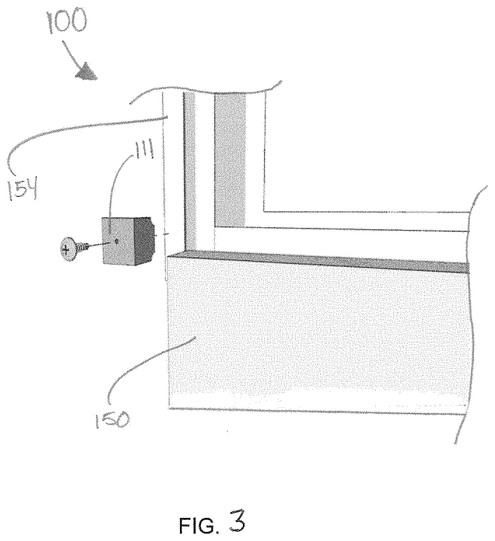

The door apparatus 100 is adapted to be installed within the metal frame 154 of an existing vent 152 in the sidewall of a poultry house to allow for additional sunlight to enter into the poultry house. The door apparatus 100 can be retrofitted where there is already an existing vent door 150 covering the vent 152. Winching on the existing vent door 150 is released prior to installation of the door apparatus 100. As shown in FIGS. 3-5, the vent door 150 is pivoted downward, and a pair of corner brackets 111, 112 are mounted at opposite lower corners of the vent 152. An elongate metal rod 106 is positioned within the lower side of the door apparatus frame 104. Opposite ends of the rod 106 extend outwardly from the frame 104 and are received within the corner brackets 111, 112. The door apparatus 100 can then pivot about the rod 106, in and out of the vent opening 152. A U-shaped latch 108 can be pivotably mounted to the vent frame 154 to function as a latch to keep the door apparatus 100 closed.

A cord 14 can be positioned through the opening 15 in the tongue member 12 of the handle apparatus 10, and the cord 14 is tied to the handle apparatus 10. Alternatively, the handle apparatus 10 can include a thumb nut that attaches the cord 14 to the handle 10. Alternatively, a cable, rope, string or other elongate connecting member can be used in place of the cord 14. A pulley 160 is mounted to the wall 156 of the poultry house, and the cord 14 is positioned through the pulley 160 and is connected to a winch 170. When the winch 170 pulls the cord 14, the cord 14 pulls the handle apparatus 10, which pulls the door apparatus 100 inward toward the vent 152 thereby tightening the seal between the door apparatus 100 and the vent 152. The handle apparatus 10 maintains closing tension on the door apparatus 100, even when the cord 14 slips or is stretched. The handle apparatus 10 provides additional tension on the door apparatus 100, whereby the door apparatus 100 provides a tight seal of the vent opening 152. This minimizes the amount of gas that can pass through the vent opening 152 when the door apparatus 100 is closed, which is of great importance in poultry houses. Also, the door apparatus 100 allows sunlight to come into the poultry house via the transparent/translucent panel 102.

The handle apparatus 10 eliminates the need for weekly vent door adjustments, and results in savings on propane. The handle apparatus 10 provides greater control over the tightness and static pressure of the poultry house, and helps eliminate write-ups for open/cracked vent doors.

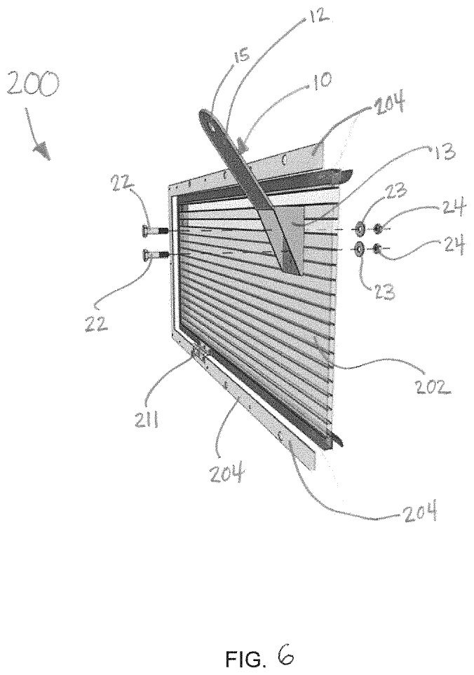

A door apparatus according to another preferred embodiment of the invention is illustrated in FIGS. 6-9, and shown generally at reference numeral 200. The door apparatus 100 comprises a transparent or translucent panel 202 contained within an outer frame 204, and the previously described handle apparatus 10. The transparent/translucent panel 102 is preferably comprised of polycarbonate, and the outer frame 204 is preferably comprised of metal.

The handle apparatus 10 is mounted on the front surface of the panel 202, as shown in FIGS. 6-9. Screws 22 can be positioned through the openings 17 of the mounting section 13 and through the panel 202, and washers 23 and bolts 24 are positioned on the screws 22 from the opposite side of the panel 202 to mount the handle apparatus 10 to the panel 202, as shown in FIG. 6. Alternatively, other suitable fasteners can be used to attach the handle apparatus 10 to the transparent/translucent panel 202.

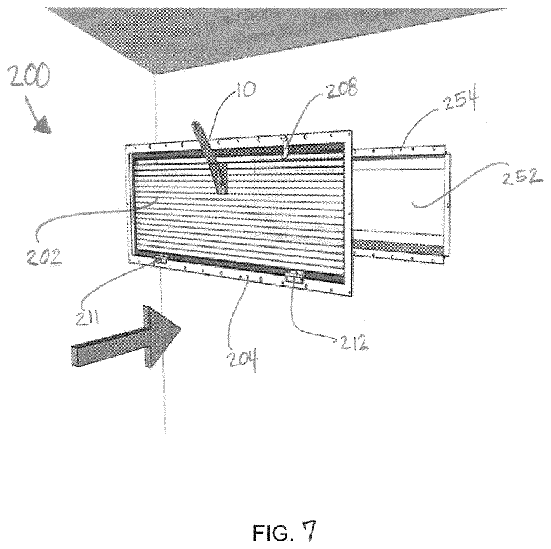

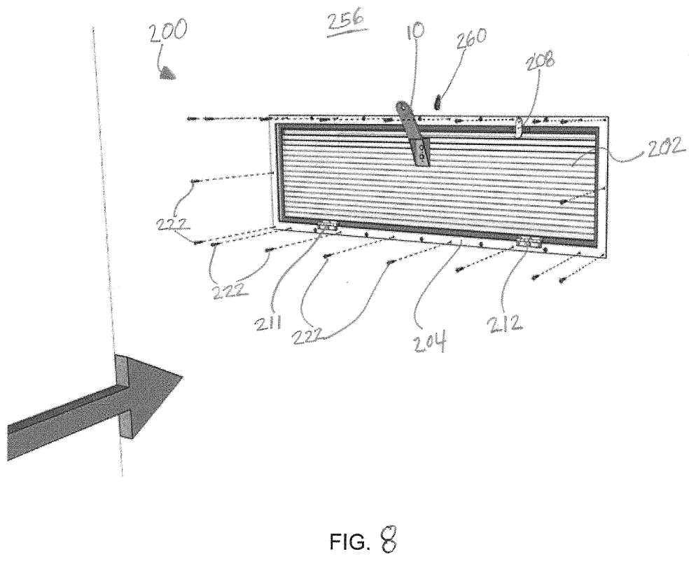

The door apparatus 200 is adapted to be installed over a vent opening 252 of a newly constructed poultry house where there is no previously existing vent door. The transparent/translucent panel 202 is attached to the bottom side of the outer frame 204 by a pair of hinges 211, 212. As such, the panel 202 can pivot about the hinges 211, 212. The outer frame 204 can be mounted to the vent frame 254 by a plurality of fasteners such as screws 222, as shown in FIGS. 7 and 8.

The door panel 202 can pivot about the hinges 211, 212, in and out of the vent opening 252. A U-shaped latch 208 can be pivotably mounted to the vent frame outer frame 204 to function as a latch to keep the door panel 202 closed.

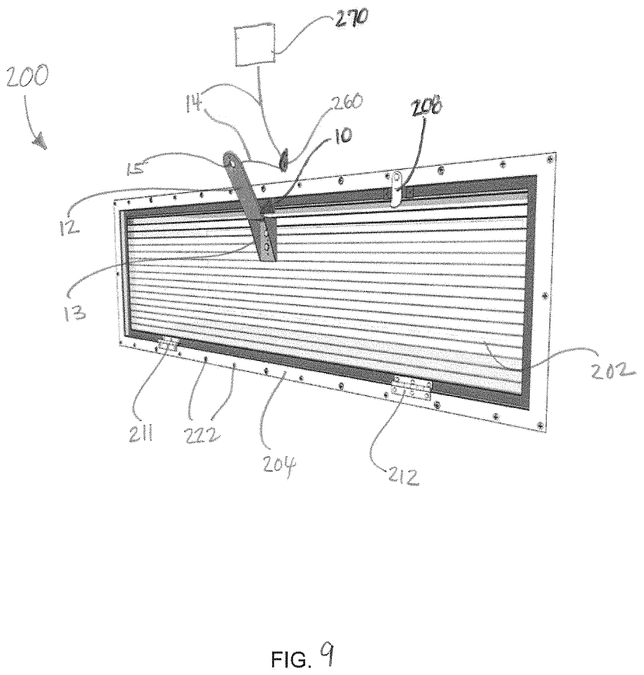

As shown in FIG. 9, a cord 14 can be positioned through the opening 15 in the tongue member 12 of the handle apparatus 10, and the cord 14 is tied to the handle apparatus 10. Alternatively, a cable, rope, string or other elongate connecting member can be used in place of the cord 14. A pulley 260 is mounted to the wall 256 of the poultry house, and the cord 14 is positioned through the pulley 260 and is connected to a winch 270. When the winch 270 pulls the cord 14, the cord 14 pulls the handle apparatus 10, which pulls the door apparatus 200 inward toward the vent 252 thereby tightening the seal between the door apparatus 200 and the vent 252. The handle apparatus 10 maintains closing tension on the door apparatus 200, even when the cord 14 slips or is stretched. The handle apparatus 10 provides additional tension on the door apparatus 200, whereby the door apparatus 200 provides a tight seal of the vent opening 252. This minimizes the amount of gas that can pass through the vent opening 252 when the door apparatus 200 is closed, which is of great importance in poultry houses. Also, the door apparatus 200 allows sunlight to come into the poultry house via the transparent/translucent panel 202.

The door apparatus 200 eliminates the need for weekly vent door adjustments, and results in savings on propane. The door apparatus 200 provides greater control over the tightness and static pressure of the poultry house, and helps eliminate write-ups for open/cracked vent doors.

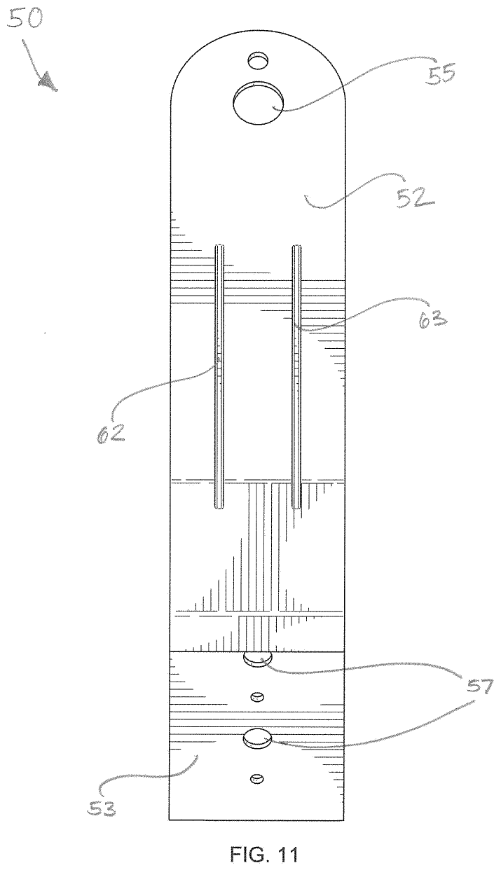

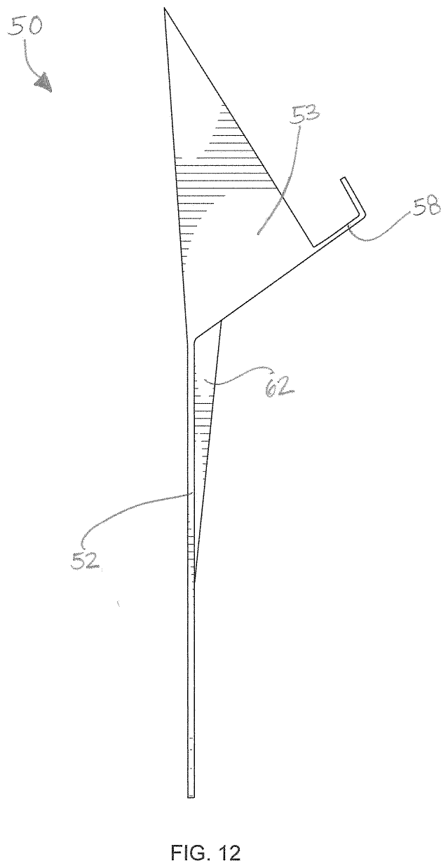

The door 200 can then be pivoted about the rod 106, in and out of the vent opening, as shown in FIGS. 11 and 12. The handle apparatus 10 can include a cord, pulley and winch (not shown), and maintain closing tension on the door 100. The transparent/translucent door apparatus 100 allows sunlight to come into the poultry house.

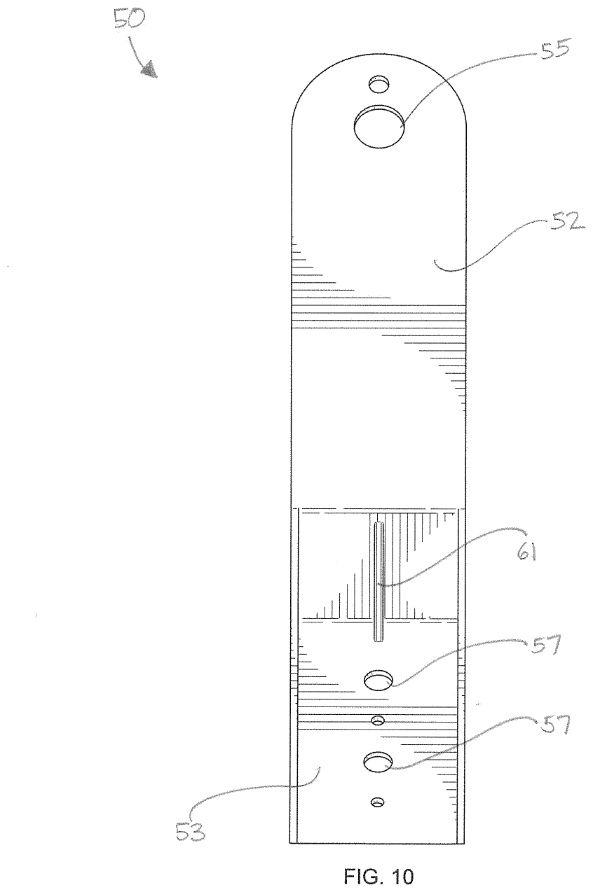

A handle apparatus according to another preferred embodiment of the invention is illustrated in FIGS. 10-12, and shown generally at reference numeral 50. The handle apparatus 50 comprises a flat tongue-shaped member 52 extending upwardly from a mounting section 53. An opening 55 is formed in the tongue-shaped member 52 to receive a cord or other elongate connecting member therethrough. A pair of openings 57 are formed in the mounting section 53 to receive fasteners therethrough to attach the handle apparatus 50 to a door. An L-shaped member 58 extends outwardly from the mounting section 53, as shown in FIG. 12.

The apparatus 50 includes a rib member 51 on a front surface of the tongue-shaped member 52, shown in FIG. 10, and a pair of longer rib members 61, 62, on the opposite back surface of the tongue-shaped member 52, as shown in FIG. 11. The rib members 51, 61, 62 provide added strength so the tongue shaped member 52 resists bending. The handle apparatus 50 is made of a strong, resilient material, such as glass filled nylon. The handle apparatus 50 can be mounted on a vent door in a poultry house, and can be used to increase the tension on the door to tighten the seal of the door and the poultry house. The handle apparatus 10 can be used on a variety of doors, including European style vent doors. The handle apparatus 50 can be a component of the previously described door apparatus 100 and door apparatus 200.

A handle apparatus and door apparatus are described above. Various changes can be made to the invention without departing from its scope. The foregoing description of embodiments of the invention are provided for the purpose of illustration only and not limitation—the invention being defined by the claims and equivalents thereof.

What is claimed is:

1. A kit for installing a door in a vent opening of a poultry house comprising:
(a) a transparent or translucent panel, the panel being substantially rectangular and positioned within a substantially rectangular frame;
(b) an elongate rod positioned within the frame, the elongate rod having first and second opposite ends extending outwardly from the frame; and
(c) a first mounting bracket for receiving the first end of the rod and a second mounting bracket for receiving the second end of the rod.

2. The kit according to claim 1, further comprising a handle apparatus attached to an outer surface of the transparent or translucent panel, wherein the handle apparatus includes an elongate section extending outwardly from the outer surface of the transparent or translucent panel and having an opening formed therein for receiving an elongate connecting member.

3. The kit according to claim 2, wherein the handle apparatus is comprised of glass filled nylon.

4. A method of installing a door apparatus in a vent opening of a poultry house comprising the steps of:
(a) providing a door apparatus comprising a transparent or translucent panel, positioned within a substantially rectangular frame, and an elongate rod partially positioned within the frame and having first and second opposite ends extending outwardly from the frame;
(b) attaching a first mounting bracket proximate a first corner of the vent opening and attaching a second mounting bracket proximate a second corner of the vent opening; and
(c) positioning the first end of the rod in the first mounting bracket and positioning the second end of the rod in the second mounting bracket, whereby the frame is pivotable about the rod between a closed position wherein the vent opening is closed by the door apparatus and an open position wherein the vent opening is exposed.

5. The method according to claim 4, wherein the door apparatus further comprises a handle apparatus attached to an outer surface of the transparent or translucent panel, wherein the handle apparatus includes an elongate section extending outwardly from the outer surface of the transparent or translucent section; and further comprising the step of attaching an elongate connecting member to the elongate section.

6. The method according to claim 5, wherein the elongate connecting member is selected from the group consisting of a cable, cord, rope and string.

7. The method according to claim 5, further comprising the step of positioning a pulley proximate the door apparatus and positioning the elongate connecting member through the pulley.

8. The method according to claim 7, further comprising the step of providing a winch and attaching an end of the elongate connecting member to the winch.
